(19) United States
(12) Patent Application Publication
(10) Pub. No.: US 2026/0077883 A1
(43) Pub. Date: Mar. 19, 2026

(54) ATTITUDE PROFILE CONTROL OF A LOW-THRUST PROPULSION EXTRATERRESTRIAL VEHICLE

(71) Applicant: Blue Origin Manufacturing, LLC, Huntsville, AL (US)

(72) Inventors: Ian Lee Elliott, Seattle, WA (US); Christopher John Sullivan, JR., Seattle, WA (US); Daniel John Grebow, Pasadena, CA (US); Martin Thomas Ozimek, Marriottsville, MD (US)

(21) Appl. No.: 19/328,040

(22) Filed: Sep. 12, 2025

Related U.S. Application Data
(60) Provisional application No. 63/694,697, filed on Sep. 13, 2024.

(51) Int. Cl. B64G 1/24; B64G 1/36

(52) U.S. Cl. CPC B64G 1/245; B64G 1/2427; B64G 1/363

(57) ABSTRACT

A vehicle capable of computing an optimal attitude path that provides increased solar power generation through snap-roll events during orbital transfer maneuvers. A vehicle may include a memory and processor, including instructions, when executed can perform the steps of generate an attitude profile of the vehicle during an orbital transfer; identify, from the attitude profile, a snap-roll event; and generate instructions to adjust an angular velocity of the vehicle during a time period corresponding to the snap-roll event to satisfy a target angular velocity.

### CROSS-REFERENCE TO RELATED APPLICATIONS

This application claims priority under 35 U.S.C. § 119 (e) to U.S. Provisional Application No. 63/694,697, entitled “ATTITUDE PROFILE CONTROL OF A LOW-THRUST PROPULSION EXTRATERRESTRIAL VEHICLE” and filed on Sep. 13, 2024, which is hereby incorporated by reference herein in its entirety.

### TECHNICAL FIELD

The present disclosure generally relates to controlling an attitude profile reference of vehicles equipped with a low-thrust propulsion system.

### BACKGROUND

Vehicles that operate in space may have a chemical propulsion system, an electrical propulsion system, or a chemical-electrical hybrid propulsion system. For example, a vehicle with a chemical propulsion system may rely on a liquid propellant, a solid propellant, or a liquid-solid hybrid propellant that generates thrust through a chemical reaction. A vehicle with a solar electrical propulsion system may rely on converting solar energy into electric heating, electric fields, or magnetic fields that generate thrust through the acceleration of propellants. Chemical propulsion systems can produce high thrusts in a given period of time, whereas electric propulsions systems can produce low thrusts in a given period of time. Thus, chemical propulsion systems are often suitable for launching vehicles or other flight operations in which a vehicle may make rapid maneuvers and/or the flight time may be short (e.g., 1 hour, 10 hours, 24 hours, etc.). On the other hand, electric propulsion systems are often suitable for transit in space (e.g., within an orbit, between orbits, etc.) in which a vehicle may not make rapid maneuvers and/or flight times may be long (e.g., 1 week, 1 month, 1 year, 5 years, etc.).

### SUMMARY

The systems, methods, and devices described herein each have several aspects, no single one of which is solely responsible for its desirable attributes. Without limiting the scope of this disclosure, several non-limiting features will now be discussed briefly.

One aspect of the disclosure provides a vehicle capable of operating in space. The vehicle comprising a memory that stores computer-executable instructions and a processor in communication with the memory. The computer-executable instructions, when executed by the processor, cause the processor to: generate an attitude profile of the vehicle during an orbital transfer, where the attitude profile identifies a direction for a thrust vector and a solar vector, where the thrust vector is associated with a direction of acceleration of the vehicle, where the solar vector is associated with a positioning of the vehicle to allow for a solar panel of the vehicle to receive sunlight; identify, from the attitude profile, a snap-roll event, where the snap-roll event is a violation event in which movement of the vehicle violates a body-frame angular rate constraint, where the snap-roll event is identified based on the solar vector and the thrust vector being in substantial alignment; and generate instructions to adjust an angular velocity of the vehicle during a time period corresponding to the snap-roll event to satisfy a target angular velocity, where adjustment of the angular velocity of the vehicle to satisfy the target angular velocity causes the vehicle to, during at least a portion of the time period, maintain the thrust vector along the attitude profile, off-point the solar vector from the attitude profile, and avoid the snap-roll event.

The vehicle of the preceding paragraph can include any sub-combination of the following features: where the body-frame angular rate constraint includes a target angular velocity range for the vehicle; where the computer-executable instructions of the vehicle, when executed, further cause the processor to identify the snap-roll event from operational motion characteristics according to the attitude profile, where the operational motion characteristics include at least one of angular velocity rates and angular acceleration limits of the vehicle; where the computer-executable instructions of the vehicle, when executed, further cause the processor to identify time bounds around the violation event, where the snap-roll event occurs within the time bounds; where the computer-executable instructions of the vehicle, when executed, further cause the processor to generate a cost function associated with the snap-roll event, where the cost function is designed to reduce solar power generation losses and determine constraints defined on the operational motion characteristics of the time bounds; where the computer-executable instructions of the vehicle, when executed, further cause the processor to generate an initial solution for computing the cost function using operational motion characteristics from the attitude profile; where the computer-executable instructions of the vehicle, when executed, further cause the processor to interpolate the operational motion characteristics across the time bounds to determine an optimal attitude path for the vehicle; where the computer-executable instructions of the vehicle, when executed, further cause the processor to generate instructions that cause adjustments to the angular velocity of the vehicle to be within a target angular velocity range for at least some time of time bounds around the violation event; where the time bounds of the violation event is one minute; where the time bounds of the violation event is adjustable; where the computer-executable instructions of the vehicle, when executed, further cause the processor to: compute a first solar power generation estimate for a first case, where the first case is an estimated amount of solar power generation in response to flipping of the vehicle, compute a second solar power generation estimate for a second case, where the second case is an estimated amount of solar power generation without flipping, determine whether to cause the vehicle to flip along an axis of the vehicle, where the determination is based on a comparison between the first case and the second case, and in response to a determination that the first solar power generation estimate is greater than the second solar power generation estimate, generate a second instruction to cause the vehicle to flip along the axis.

Another aspect of the disclosure provides a method comprising: obtaining a direction for a thrust vector and a solar vector of an extraterrestrial vehicle, where the thrust vector is associated with a direction of acceleration of the extraterrestrial vehicle, where the solar vector is associated with a positioning of the extraterrestrial vehicle to allow for a solar panel of the extraterrestrial vehicle to receive sunlight; identifying a position along a trajectory for which the solar vector and the thrust vector are in substantial alignment; and in response to identifying the position, generating instructions to adjust an angular velocity of the extraterrestrial vehicle at the position to satisfy a target angular velocity, where adjustment of the angular velocity of the extraterrestrial vehicle to satisfy the target angular velocity causes the extraterrestrial vehicle to, at the position, maintain the thrust vector and off-point the solar vector.

The method of the preceding paragraph can include any sub-combination of the following features: where the target angular velocity is within a target angular velocity range for the extraterrestrial vehicle; further comprising identifying alignment of the solar vector and the thrust vector from operational motion characteristics of the extraterrestrial vehicle, where the operational motion characteristics include at least one of angular velocity rates and angular acceleration limits of the extraterrestrial vehicle; further comprising identifying time bounds around alignment of the solar vector and the thrust vector; further comprising generating instructions that cause adjustments to the angular velocity of the extraterrestrial vehicle to be within a target angular velocity range for at least some time of time bounds; further comprising generating a cost function associated with alignment of the solar vector and the thrust vector, where the cost function is designed to reduce solar power generation losses and determine constraints defined on the operational motion characteristics of the time bounds; further comprising generating an initial solution for computing the cost function using operational motion characteristics; further comprising interpolating the operational motion characteristics across the time bounds to determine an optimal attitude path for the extraterrestrial vehicle; further comprising: computing a first solar power generation estimate for a first case, where the first case is an estimated amount of solar power generation in response to flipping of the extraterrestrial vehicle, computing a second solar power generation estimate for a second case, where the second case is an estimated amount of solar power generation without flipping, determining whether to cause the extraterrestrial vehicle to flip along an axis of the extraterrestrial vehicle, where the determination is based on a comparison between the first case and the second case, and in response to a determination that the first solar power generation estimate is greater than the second solar power generation estimate, generating a second instruction to cause the extraterrestrial vehicle to flip along the axis.

Another aspect of the disclosure provides a vehicle capable of operating in space, the vehicle comprising: a memory that stores computer-executable instructions; and a processor in communication with the memory, where the computer-executable instructions, when executed by the processor, cause the processor to: generate an attitude profile of the vehicle during an orbital transfer, where the attitude profile identifies a direction for a first vector and a second vector, where the first vector is associated with a positioning of the vehicle to allow for solar panels of the vehicle to receive sunlight; identify, from the attitude profile, a snap-roll event, the snap-roll event is a violation event in which movement of the vehicle violates a body-frame angular rate constraint, where the snap-roll event is identified based on the first vector and the second vector being in substantial alignment; identify a plurality of control points along a trajectory of the vehicle during the snap-roll event; and adjust angular velocity of the vehicle at a first control point in the plurality of control points, where a first angular velocity of the vehicle at the first control point exceeds a maximum angular velocity of the vehicle.

The vehicle of the preceding paragraph can include any sub-combination of the following features: where the body-frame angular rate constraint includes a target angular velocity range for the vehicle; where the computer-executable instructions of the vehicle, when executed, further cause the processor to identify the snap-roll event from operational motion characteristics according to the attitude profile, where the operational motion characteristics include at least one of angular velocity rates and angular acceleration limits of the vehicle; where the computer-executable instructions of the vehicle, when executed, further cause the processor to identify time bounds around the violation event, where the snap-roll event occurs within the time bounds; where the computer-executable instructions of the vehicle, when executed, further cause the processor to, for each snap-roll event, determine control parameters for some of the plurality of control points; where the computer-executable instructions of the vehicle, when executed, further cause the processor to generate a cost function associated with the snap-roll event, where the cost function reduces losses associated with off-pointing of the second vector and determines constraints defined on the operational motion characteristics between neighboring control points; where the computer-executable instructions of the vehicle, when executed, further cause the processor to generate an initial solution for computing the cost function using operational motion characteristics from the attitude profile; where the computer-executable instructions of the vehicle, when executed, further cause the processor to interpolate the operational motion characteristics between the plurality of control points to determine an optimal attitude path for the vehicle; where the computer-executable instructions of the vehicle, when executed, further cause the processor to generate instructions that cause adjustments to the angular velocity of the vehicle to be within a target angular velocity range for at least some time of time bounds around the violation event; where the second vector is aligned to one of: a communications system or relay, an antenna, an area of space to capture with a telescope, or a defense target.

Another aspect of the disclosure provides a method, comprising: obtaining a direction for a first vector and a second vector, where the first vector is associated with a positioning of an extraterrestrial vehicle to allow for a solar panel of the extraterrestrial vehicle to receive sunlight; identifying a position along a trajectory for which the first vector and the second vector are in substantial alignment; in response to identifying the position, identifying a plurality of control points along the trajectory of the extraterrestrial vehicle; and adjusting angular velocity of the extraterrestrial vehicle at a first control point in the plurality of control points, where a first angular velocity of the extraterrestrial vehicle at the first control point exceeds a maximum angular velocity of the extraterrestrial vehicle.

The method of the preceding paragraph can include any sub-combination of the following features: where adjusting the angular velocity of the extraterrestrial vehicle at the first control point further comprises adjusting the angular velocity of the extraterrestrial vehicle at the first control point to be within a target angular velocity range; further comprising identifying alignment of the first vector and the second vector from operational motion characteristics of the extraterrestrial vehicle, where the operational motion characteristics include at least one of angular velocity rates and angular acceleration limits of the extraterrestrial vehicle; further comprising identifying time bounds around alignment of the first vector and the second vector; further comprising generating instructions that cause adjustments to the angular velocity of the extraterrestrial vehicle to be within a target angular velocity range for at least some time of time bounds; further comprising determining control parameters for some of the plurality of control points; further comprising generating a cost function associated with alignment of the first vector and the second vector, where the cost function reduces losses associated with off-pointing of the second vector and determines constraints defined on the operational motion characteristics between neighboring control points; further comprising generating an initial solution for computing the cost function using operational motion characteristics; further comprising interpolating the operational motion characteristics between the plurality of control points to determine an optimal attitude path for the extraterrestrial vehicle; where the second vector is aligned to one of: a communications system or relay, an antenna, an area of space to capture with a telescope, or a defense target.

Another aspect of the disclosure provides a vehicle capable of operating in space. The vehicle comprises a memory that stores computer-executable instructions. The vehicle further comprises a processor, in communication with the memory, where the computer-executable instructions, when executed by the processor, cause the processor to generate a nominal attitude profile during an orbital transfer, wherein the nominal attitude profile allows for the vehicle to generate solar power; identify snap-roll events from operational motion characteristics according to the nominal attitude profile, including angular velocity rates and angular acceleration limits of the vehicle, wherein each of the snap-roll events corresponds to time bounds around each of the snap-roll events; for each snap-roll event, separate the respective time bound into discrete points and determine control parameters at each of the discrete points; generate a cost function associated with the snap-roll events, wherein the cost function is designed to reduce solar power generation losses and determine constraints defined on the operational motion characteristics between neighboring control points; generate an initial solution for computing the cost function using operational motion characteristics from an attitude profile; and interpolate the operational motion characteristics between the discrete control points to determine an optimal attitude path for the vehicle.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIGS. 1A-1B are an extraterrestrial vehicle with reference attitude and performing an attitude maneuver (called a “snap-roll”).

FIG. 2 is a block diagram of an illustrative operating environment in which a space-based computing system controls, for an extraterrestrial vehicle, an attitude profile reference.

FIG. 3 is a flow diagram depicting an attitude profile control routine illustratively implemented by a space-based computing system, according to one embodiment.

FIGS. 4A-4B are diagrams representing mitigation of a snap-roll event for an extraterrestrial vehicle implementing an orbital transfer and adjustments to orientation according to the orbital transfer.

FIGS. 4C-4F are example graphs illustrating measurements associated with mitigation of the snap-roll event for the extraterrestrial vehicle's movement.

FIG. 5 is an illustrative routine to adjust position of an extraterrestrial vehicle according to an attitude profile.

FIG. 6 is an illustrative routine for controlling an attitude profile reference for the extraterrestrial vehicle to adjust an orbital path.

FIG. 7 is a block diagram of an illustrative computing system configured to perform actions of an extraterrestrial vehicle, such as compute adjustments to attitude, according to some embodiments.

### DETAILED DESCRIPTION

As described above, electric propulsion systems generally produce low thrusts and are therefore suitable for vehicles traveling in space along trajectories in which rapid maneuvers are not involved. For example, a vehicle with an electric propulsion system may receive a command to travel from point A in space (e.g., a first position in a first orbit) to point B in space (e.g., a second position in the first orbit, a first position in a second orbit, etc.) along a certain trajectory. Given the solar power reliance of the electric propulsion onboard the vehicle, it is often desirable to select a trajectory for the vehicle that maximizes solar power generation.

Determining a trajectory that maximizes solar power generation can be difficult, however. In orbit change maneuvers, a spacecraft using low-thrust propulsion often needs to maintain an attitude that maximizes solar power generation while maintaining a fuel-efficient trajectory, especially during extended burns. This alignment ensures that solar panels remain optimally positioned to capture sunlight, which is critical for long-duration missions relying on solar power. When the fuel-efficient thrust direction aligns closely (e.g., within a threshold angle, such as 1°, 5°, 10°, etc.) with a line between the spacecraft and the solar energy source (e.g., the sun, a star, etc.), however, maintaining such an attitude can cause the spacecraft to undergo snap-rolls. A snap-roll is a situation where the spacecraft's angular velocity rapidly increases, potentially exceeding its control capabilities. These snap-rolls occur when the spacecraft adjusts its attitude between the fuel-efficient thrust direction and the line between the spacecraft and the solar energy source, but does so too abruptly, causing a destabilizing effect. Current mitigation approaches often involve adjusting the spacecraft's attitude in a way that misaligns it temporarily from the optimal angle for solar power generation. While this may reduce the risk of snap-rolls, it can lead to reduced power efficiency, compromising the spacecraft's energy supply during critical orbital changes.

Conventional methods attempt to design an attitude profile that may be achievable by the spacecraft's attitude control systems during a snap-roll event. In general, there are three general design choices when developing an alternative attitude profile to satisfy agility constraints during snap-roll events. First, a design may attempt to maintain the solar panel axis pointing such that the spacecraft can continue generating full solar power during the snap-roll event. However, the thruster axis of the spacecraft is then temporarily misaligned from the reference thrust direction to satisfy the agility constraints. In this way, the solar power generation of the spacecraft suffers due to the misalignment of the solar array with the sun direction. The misalignment of the solar arrays may lead to insufficient solar exposure, which may cause the spacecraft to lose energy during the orbital change. Second, a design may attempt to mitigate snap-rolls by holding the thruster axis of the spacecraft aligned with the reference thrust direction and modify the solar panel axis until the angular constraints of the spacecraft are met. However, the maneuver may cause a temporary reduction in a solar power generation due to the off-pointing of the solar arrays. Even though the translational motion of the spacecraft can remain largely unaffected by the snap-roll event if the spacecraft can generate enough power during the snap-roll, the maneuver inserts a coast to the orbital trajectory, which extends the orbit transfer time and may increase energy demands. The design options may increase the time required to complete the orbit transfer which can reduce the maximum design performance of the vehicle or delay on-station operations. Thus, conventional methods may be inefficient in generating solar power during orbital transfers for low thrust spacecraft.

Accordingly, the present disclosure is directed to a new process for adjusting orbital trajectories in a manner that provides efficient orbital trajectory adjustment without the decrease of solar power generation as described above. For example, a terrestrial-based computing system or a space-based computing system (or a vehicle traveling in space) can apply a multi-step process that (1) generates a nominal attitude profile during an orbital transfer that enables full solar power generation; (2) identifies snap-roll events using the angular velocity rates and angular acceleration limits of the spacecraft and define time bounds around each event; (3) for each snap-roll event, creates a discrete grid of times within the time bounds of the respective snap-roll event and defines discrete control points at each time within the time bounds; (4) formulates an optimization problem with a cost function designed to minimize solar power generation losses and constraints defined on angular rate and angular acceleration between neighboring control points; (5) generates an initial solution for the optimization problem using information from the original attitude profile; (6) computes the optimization problem using analytical techniques; and (7) interpolates the spacecraft's attitude and angular rates between the discrete control points. In some cases, the spacecraft may repeat some or all of the steps for each snap-roll event during the transfer. The multi-step process described herein is designed to optimize orbital trajectory change and solar power generation of the spacecraft. The functionality implemented by the space-based computing system (or a terrestrial-based computing system) may be suited to solve transfers with long trip times (e.g., transfers by vehicles with electric or hybrid propulsion) because the adjustment of the attitude profile may not decrease the solar power generation of the spacecraft.

While the present disclosure describes a space-based computing system as executing the processes described herein, this is for illustrative purposes and is not meant to be limiting. For example, a vehicle traveling in space may communicate with one or more processors and memory that store computer-executable instructions, where the computer-executable instructions, when executed by the processor(s), cause the processor(s) to implement the processes described herein and transmit instructions to cause the vehicle to adjust a trajectory. In this example, another system (such as a terrestrial-based system) may be able to determine an orbit trajectory to maximize solar power generation while following a trajectory, about a central body.

The foregoing aspects and many of the attendant advantages of this disclosure will become more readily appreciated as the same become better understood by reference to the following detailed description, when taken in conjunction with the accompanying drawings.

### Example Low-Thrust Propulsion Vehicle Attitude Dynamics

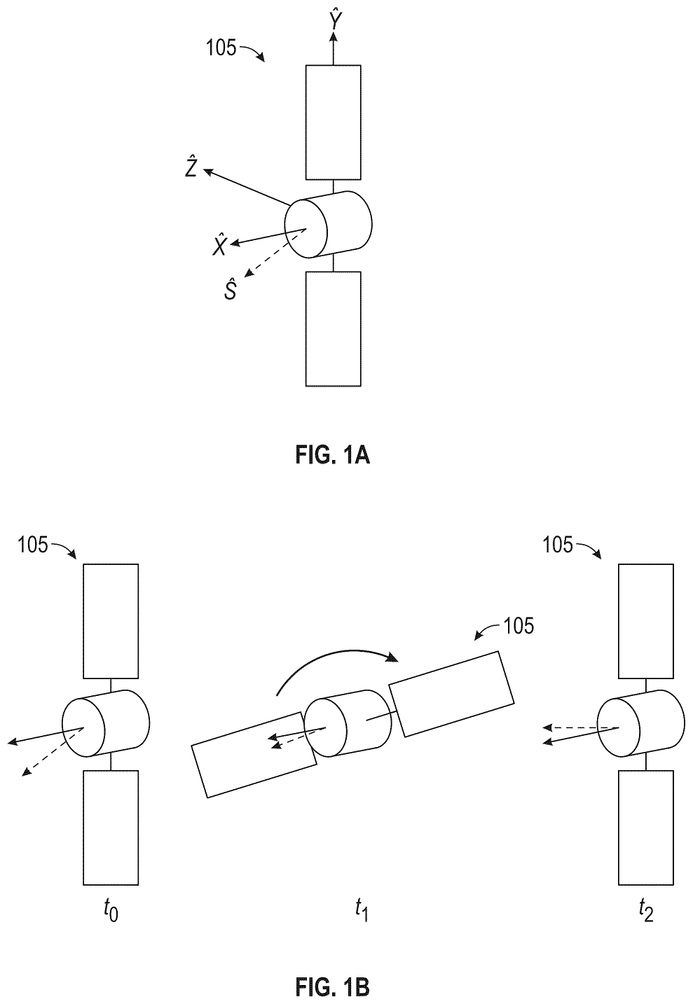

FIGS. 1A-1B illustrate an example extraterrestrial vehicle 105, with a reference attitude profile, performing an attitude maneuver. As illustrated in FIG. 1A, the extraterrestrial vehicle 105 may have reference attitude while operating in space. For example, the reference attitude profile may follow the axes described below:

$${X}_{sc} = {P}_{in} , {Y}_{sc} = \frac{{X}_{sc} \times S}{\vert {X}_{sc} \times S \vert} , {Z}_{sc} = {X}_{sc} \times {Y}_{sc} \qquad ( 1 )$$

Where X_{sc} (direction of thrust) is the X-axis and is pointed in an optimal direction determined by analytical techniques (such as an indirect optimization scheme to develop electric propulsion trajectories for transfers including orbit raising, maneuvers for GEO insertion, and maneuvers for GEO station keeping), Y_{sc} (direction of solar panels) is the Y-axis and defined by computing a cross product of the X_{sc} with sun-direction(S), and Z_{sc} is the Z-axis and is defined by computing a cross product of X_{sc} and Y_{sc}. The sun-direction(S) may be determined as:

$$S = \frac{{\vec{r}}_{sc} - {\vec{r}}_{s}}{\vert {\vec{r}}_{sc} - {\vec{r}}_{s} \vert} \qquad ( 2 )$$

Where \vec{r}_{sc} is the position of the spacecraft relative to the central body and rs is the position of the sun relative to the central body. In this way, computing a cross product with a sun direction allows solar panels onboard the extraterrestrial vehicle 105 (along the Y_{sc}) to get full view of the sun (assuming they can rotate freely about the Y_{sc}). In some examples, other axes may be used for the cross product.

As illustrated in FIG. 1B, during long-duration trajectory adjustment maneuvers (for example, thousands of orbits around a central body), the extraterrestrial vehicle 105 standard attitude definition can sometimes result in unrealistic angular rates and accelerations, referred to as “snap-roll” events. These events occur due to alignment of the electric propulsion thrust direction and the direction of the sun from the extraterrestrial vehicle 105 causing a mathematical singularity in the extraterrestrial vehicle 105 attitude definition. For example, a thrust vector and a solar vector may be in substantial alignment. Substantial alignment may include the solar vector being between 0-degrees and 5-degrees offset from the thrust vector. In some examples, the vectors may be in moderate alignment. Moderate alignment may include the vectors being between 5-degrees and 90-degrees offset. The extraterrestrial vehicle 105 may avoid angular rate violations during snap-roll events by off-pointing the solar panels from the sun (or another star). The off-pointing, however, may reduce the amount of solar power generation by adjusting the position of the solar panels away from the sun.

In some examples, snap-rolls occur during an orbit transfer when the extraterrestrial vehicle 105 attempts to align the thruster axis along the optimal thrust direction and align the solar array axis of the extraterrestrial vehicle 105 such that the solar arrays can receive full solar power. With these two pointing constraints placed on the attitude of the extraterrestrial vehicle 105, snap-rolls can potentially occur when the thrust vector of the extraterrestrial vehicle 105 aligns closely with the line between the extraterrestrial vehicle 105 and the sun (or another star). During this scenario, as illustrated in FIG. 1B, the nominal direction of the solar panel axis is nearly undefined. This singularity can cause the resulting attitude profile to require unrealistic angular rates and accelerations that may violate the agility constraints of the extraterrestrial vehicle 105. As the extraterrestrial vehicle 105 slews over time following the orbital trajectory and the X_{sc} and sun-direction are nearly-aligned, the pointing definition of the Y_{sc} may become highly sensitive due to the attitude profile of the extraterrestrial vehicle 105. In this way, the Y_{sc} of the extraterrestrial vehicle 105 may roll rapidly about the X_{sc}.

When avoiding a snap-roll to satisfy the agility constraints of the extraterrestrial vehicle 105, the extraterrestrial vehicle 105 may be required to off-point the thruster from the optimal thrust direction, to add a coast segment in the trajectory, or to off-point the solar panel axis, resulting in a loss of solar power generation. These options can increase the time required to complete the orbit transfer which can reduce the maximum design performance of the vehicle or delay on-station operations. To avoid these impacts, alternative strategies during snap-roll events are desired.

### Example Low-Thrust Propulsion Vehicle Operating Environment

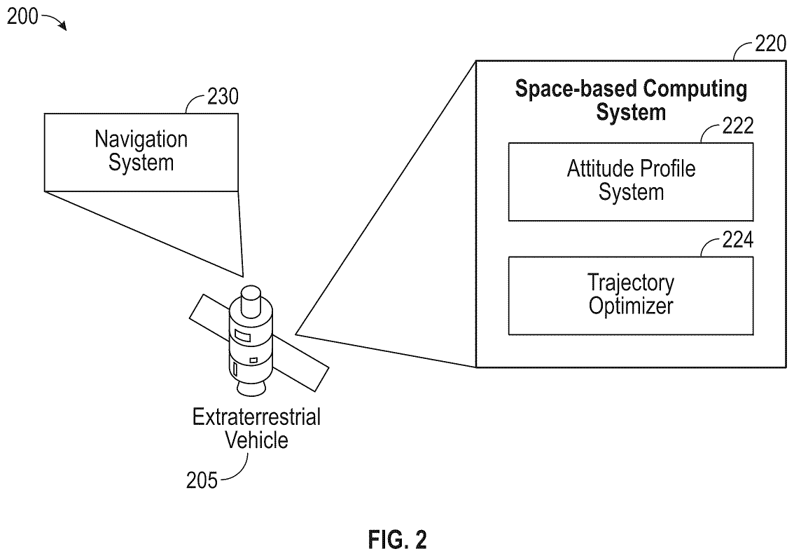

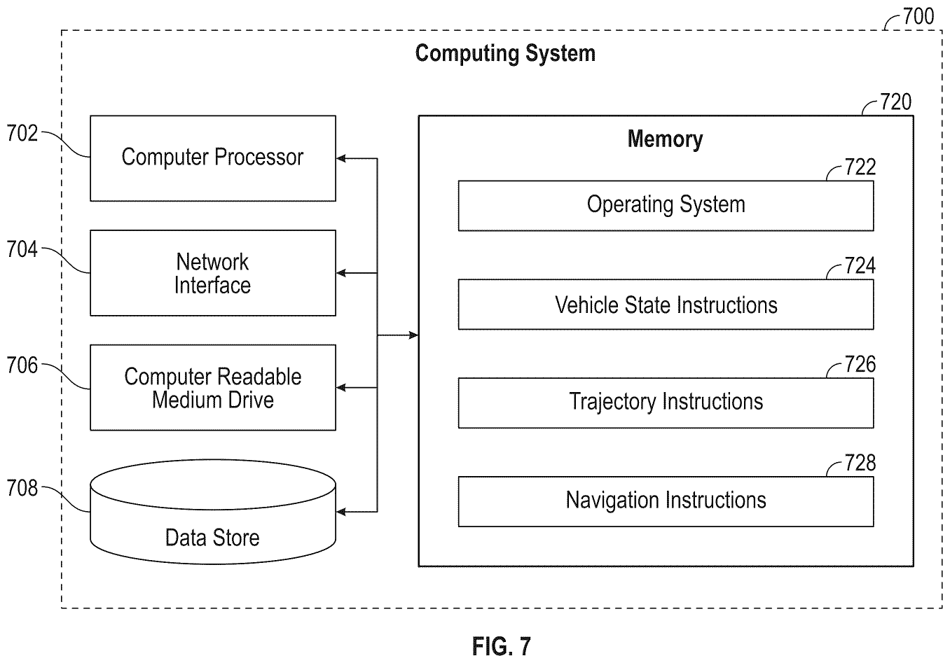

FIG. 2 is a block diagram of an illustrative operating environment 200 in which a space-based computing system 220 controls, for an extraterrestrial vehicle 205, an attitude profile to perform an orbital transfer and ensure optimum solar power generation. The extraterrestrial vehicle 205 may be a space lander (e.g., a lander configured to land on a celestial body, such as a moon, a planet, an asteroid, etc.), a rover, a rocket, a satellite, a spaceship, a space shuttle, and/or any other type of vehicle that is capable of operating in space and/or on an extraterrestrial object other than Earth. The extraterrestrial vehicle 205 may also be referred to herein as “spacecraft.” Even though the approaches described herein are in reference to computing adjustments to the position by the extraterrestrial vehicle 205, the approaches may be performed by a ground-based system (such as computing system 700 in FIG. 7) with compute resources capable of performing the computations, steps, etc. as described herein. For example, the ground-based system may execute instructions to perform computations of position adjustments for the extraterrestrial vehicle 205 to mitigate snap-roll events. The ground-based system may provide instructions to the extraterrestrial vehicle 205 to perform position adjustments to mitigate the snap-roll events. The extraterrestrial vehicle 205 may include an electric propulsion system or a chemical-electric hybrid propulsion system. Thus, the extraterrestrial vehicle 205 may operate in a low-thrust environment. As described herein, “space” may include outer space or any location outside of Earth's orbit. For example, “space” may be with respect to an extraterrestrial vehicle traveling in low-Earth orbit (LEO), geostationary orbit (GEO), or interstellar travel in outer space with or without interaction with a terrestrial-based system.

The space-based computing system 220 may include various modules, components, data stores, and/or the like to provide the motion planning functionality described herein. For example, the space-based computing system 220 may include an attitude profile system 222 and a trajectory optimizer 224.

The space-based computing system 220 can use modified equinoctial elements (MEEs) as a primary representation of the state of the extraterrestrial vehicle 205 relative to a central body for the operations described herein. For example, the space-based computing system 220 may calculate equations of motion (and/or initial condition values) based on known or obtained parameter values associated with the extraterrestrial vehicle 205 (e.g., the space-based computing system 220 may obtain parameter values associated with the extraterrestrial vehicle 205 from the extraterrestrial vehicle 205 itself, from one or more sensors located in space, from a separate terrestrial-based system, not shown, etc.).

For example, the attitude profile system 222 of the space-based computing system 220 can derive an equation of motion for the extraterrestrial vehicle 205. For example, the attitude profile system 222 may derive the equation of motion by averaging the full-state equations of motion applying the indirect optimal control strategy (e.g., indirect optimization). In this way, the equation of motion may be an averaged equation of motion. In some cases, the equation of motion may be a real-time equation of motion of the extraterrestrial vehicle 205, a predicted equation of motion of the extraterrestrial vehicle 205, or another type of equation of motion with respect to dynamics of the extraterrestrial vehicle 205.

The extraterrestrial vehicle 205 includes a navigation system 230. The navigation system 230 may determine and control the position, velocity, and orientation of the extraterrestrial vehicle 205 in space using onboard components. For example, the navigation system 230 may receive inputs from the space-based computing system 220, which may include inputs from one or more of sensors, a computer, and propulsion systems. In some examples, the sensors may include star trackers, sun sensors, gyroscopes, accelerometers, GPS receivers, and radio tracking systems. The sensor(s) may provide real-time data that the navigation system 230 may process to monitor the trajectory of the extraterrestrial vehicle 205. The propulsion system may include thrusters and main engines. The propulsion system may execute trajectory adjustments based on calculations from the navigation system 230.

When the navigation system 230 adjusts from a first orbit to a second orbit, the navigation system 230 may detect the current trajectory and compute the orbital changes to reach the second orbit. The navigation system 230 may provide sensor data to the space-based computing system 220. In this manner, the space-based computing system 220 may determine the changes in navigation and component parameters and plan the maneuvers. For example, to move from a LEO to a higher orbit, the space-based computing system 220 may calculate a transfer orbit burn with low-thrust engines. The low-thrust engines of the extraterrestrial vehicle 205 then executes the burn to increase velocity, moving the extraterrestrial vehicle 205 into an elliptical transfer orbit. At the apogee of this orbit, another burn is performed to circularize the orbit, achieving the final desired orbit.

In some examples, the extraterrestrial vehicle 205 may traverse a reference trajectory. The reference trajectory may include a path for the extraterrestrial vehicle 205 to follow to reach a target destination. In some examples, the reference trajectory (and any other computation as disclosed herein) may be similar or identical to and/or incorporate any of the features described and/or illustrated with respect to any of the devices, assemblies, systems, and/or methods described and/or illustrated in U.S. application Ser. No. 18/793,700, filed Aug. 2, 2024, entitled “SYSTEMS AND METHODS FOR LOW-THRUST PROPULSION TRAJECTORY OPTIMIZATION USING A MINIMUM PROPELLANT TRANSFER,” U.S. application Ser. No. 18/793,696, filed Aug. 2, 2024, entitled “SYSTEMS AND METHODS FOR LOW-THRUST PROPULSION TRAJECTORY OPTIMIZATION USING A MINIMUM TIME TRANSFER,” U.S. application Ser. No. 18/793,695, filed Aug. 2, 2024, entitled “LOW-THRUST PROPULSION VEHICLE WITH TRAJECTORY OPTIMIZATION USING MINIMUM PROPELLANT TRANSFER,” and U.S. application Ser. No. 18/793,710, filed Aug. 2, 2024, entitled “LOW-THRUST PROPULSION VEHICLE WITH TRAJECTORY OPTIMIZATION USING MINIMUM TIME TRANSFER,” which are hereby incorporated by reference in its entirety and for all purposes.

### Example Data Flow Interactions For Extraterrestrial Vehicle

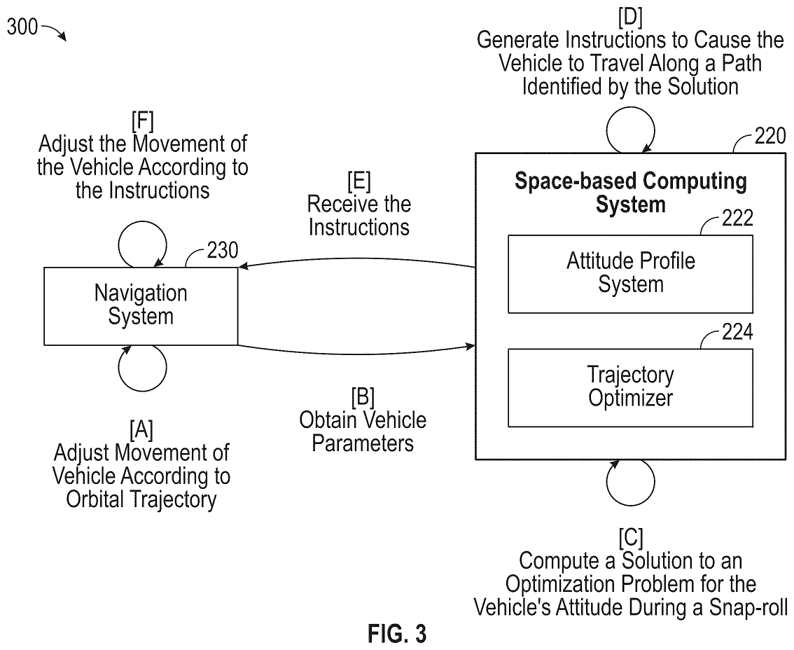

FIG. 3 is a diagram 300 of illustrative data flows and interactions between a space-based computing system 220 and a navigation system 230, each of which may be included onboard an extraterrestrial vehicle 205, to determine a trajectory change for the extraterrestrial vehicle 205 to adjust an orbital path.

At [A], the navigation system 230 adjusts movement of an extraterrestrial vehicle 205 according to orbital trajectory. The engine controls may adjust movement with respect to navigation parameters (for example, increasing or reducing thrust according to the navigation parameters). In some examples, the navigation system 230 provides the navigation parameters to engine controls for adjusting the movement of the extraterrestrial vehicle 205. For example, the navigation system 230 may obtain navigation parameters about position, orientation, speed (and/or velocity), guidance, or another parameter relevant to monitoring movement of the extraterrestrial vehicle 205. The parameters disclosed herein may be with and/or without regards to a celestial body or a location of a terrestrial-based system.

In some cases, the movement of the extraterrestrial vehicle 205 may follow the orbital trajectory. For example, the orbital trajectory may include predetermined orbital characteristics for the extraterrestrial vehicle 205 to follow (for example, orbiting a celestial body). The predetermined characteristics may include variations of the navigation parameters as disclosed herein. In some cases, the extraterrestrial vehicle 205 may move outside of the orbital trajectory (or be at risk of moving outside the orbital trajectory), for example, in response to an external force acting on the extraterrestrial vehicle 205 (being struck by, or coming into close contact with, space debris). In this manner, the navigation system 230 may obtain the navigation parameters and send the navigation parameters to engine controls to adjust the movement of the extraterrestrial vehicle 205.

At [B], the space-based computing system 220 obtains vehicle parameters from the navigation system 230. In some examples, the vehicle parameters may at least include the navigation parameters and/or component parameters. For example, the navigation parameters may include parameters as disclosed herein. In some examples, the component parameters may include fuel levels, component health (engines, thrusters, etc.), component performance, predicted capabilities, or another component parameter associated with components of the extraterrestrial vehicle 205.

At [C], the space-based computing system 220 computes a solution to an optimization problem for an attitude of the extraterrestrial vehicle 205 during a snap-roll. In some examples, the space-based computing system 220 may generate a nominal attitude profile during an orbital transfer. In some cases, the nominal attitude allows for solar power generation above a solar power generation threshold. For example, the nominal attitude may allow for solar power generation above 80% of a capacity that the extraterrestrial vehicle 205 is able to generate. The nominal attitude profile may correspond to the attitude profiles as disclosed herein (for example, the attitude profile according to Equation (1) as described in FIG. 1A). In some cases, the space-based computing system 220 may determine the nominal attitude profile according to a geometric attitude law (such as a constrained geometric attitude for a rigid body).

In some examples, the space-based computing system 220 may identify snap-roll events. For example, the space-based computing system 220 may monitor operational motion characteristics to determine a probability of a snap-roll event. For example, the operational motion characteristics may include angular velocity, angular acceleration, etc. In some cases, the space-based computing system 220 may monitor an angular velocity rate and angular acceleration limit of the extraterrestrial vehicle 205. In this way, the space-based computing system 220 may determine one or more time durations for when the operational motion characteristics reach threshold values and/or limits associated with the particular characteristic. For example, the space-based computing system 220 may determine time durations for when angular velocity rate is above an angular velocity threshold and/or when the extraterrestrial vehicle 205 achieves the angular acceleration limit. The angular velocity threshold may be between approximately-2 deg/s and +2 deg/s, for example, between approximately-1.5 deg/s and +1.5 deg/s, between approximately-1.0 deg/s and +1.0 deg/s, between approximately-0.5 deg/s and +0.5 deg/s. The angular acceleration limit may be between approximately-0.001 deg/s² and approximately 0.001 deg/s², for example, between approximately-0.0009 deg/s² and approximately 0.0009 deg/s², between approximately-0.0008 deg/s² and approximately 0.0008 deg/s², between approximately-0.0007 deg/s² and approximately 0.0007 deg/s², between approximately-0.0006 deg/s² and approximately 0.0006 deg/s², between approximately-0.0005 deg/s² and approximately 0.0005 deg/s², between approximately-0.0004 deg/s² and approximately 0.0004 deg/s², between approximately-0.0003 deg/s² and approximately 0.0003 deg/s², between approximately-0.0002 deg/s² and approximately 0.0002 deg/s², between approximately-0.0001 deg/s² and approximately 0.0001 deg/s², or any value or range between any of these values or ranges or any value or range bounded by any combination of these values, although values or ranges outside these values or ranges can be used in some cases. In some cases, the space-based computing system 220 may classify the time durations as snap-roll events.

In some examples, the space-based computing system 220 may, for each snap-roll event, separate the time durations into discrete control points and determine control parameters at each of the discrete control points. The discrete control points may be separated from one another be between approximately 0 and approximately 360 seconds(s), for example, between approximately 30 s and approximately 330 s, between approximately 60 s and approximately 300 s, between approximately 90 s and approximately 270 s, between approximately 120 s and approximately 240 s, between approximately 150 s and approximately 210 s, between approximately 180 s and approximately 180 s, or any value or range between any of these values or ranges or any value or range bounded by any combination of these values, although values or ranges outside these values or ranges can be used in some cases.

In some examples, the space-based computing system 220 may generate a cost function associated with the snap-roll events. In some cases, the space-based computing system 220 may generate the cost function designed to reduce solar power generation losses and determine constraints defined on operational motion characteristics, such as angular rate and angular acceleration between neighboring control points. The space-based computing system 220 may apply optimization techniques to compute the cost function to ensure reduced solar power generation loss (as described in more detail below).

In some examples, the space-based computing system 220 may generate an initial solution for computing the cost function using operational motion characteristics from an attitude profile (such as the nominal attitude profile). In some examples, the space-based computing system 220 may obtain the initial solution from boundary conditions from an orbital trajectory. For example, the space-based computing system 220 may determine orbital characteristics of the extraterrestrial vehicle 205 from initial and final orbits (in some cases, assuming constant thrust).

In some examples, the space-based computing system 220 may compute solutions to the cost function using analytical techniques. In some cases, the space-based computing system 220 may apply gradient-based optimization techniques to compute the solutions to the cost function. In some examples, the space-based computing system 220 may apply software tools capable of solving the cost function (for example, nonlinear programming solving software, such as Interior Point Optimizer (IPOPT)). In some cases, the space-based computing system 220 may solve the cost function, which may include a nonlinear programming problem with the following form:

$${min}_{x ∈ {ℝ}^{n}} f ( x ) s . t . {g}^{L} \leq g ( x ) \leq {g}^{U} and {x}^{L} \leq x \leq {x}^{U} \qquad ( 3 )$$

Where x∈ [symbol] ⁿ are the optimization variables (possibly with lower and upper bounds, x^{L}∈(R)∪{−∞}ⁿ and x^{U} ∈( [symbol] ∪{+∞})ⁿ) with x^{L}≥x^{U}, f: [symbol] ⁿ→ [symbol] is the objective function, and g: [symbol] ⁿ→ [symbol] ^{m} are the general nonlinear constraints. The functions ƒ(x) and g(x) can be linear or nonlinear and convex or non-convex (but should be twice continuously differentiable). The constraint function, g(x), has lower and upper bounds, g^{L}∈( [symbol] ∪{−∞})^{m} and g^{U}∈( [symbol] ∪{+∞})^{m}) with g^{L}≤g^{U}. In some cases, the equality constraints of the form gᵢ(x)=g̅ₜ can be specified by setting.

$${g}_{i}^{L} = {g}_{i}^{U} = \overline{{g}_{ι}} .$$

In some examples, the space-based computing system 220 may interpolate operational motion characteristics of the extraterrestrial vehicle 205. For example, the space-based computing system 220 may interpolate the attitude and angular rates between discrete control points. The space-based computing system 220 may determine controls for the extraterrestrial vehicle 205 according to the solutions to the cost function and interpolation between the operational motion characteristics. The controls determined by the space-based computing system 220 may provide an optimal attitude path to ensure increased solar power generation for the extraterrestrial vehicle 205. In some cases, the spacecraft may repeat some or all of the steps for each snap-roll event during the transfer.

At [D], the space-based computing system 220 generates instructions for causing the extraterrestrial vehicle 205 to travel along the optimal attitude path. For example, the instructions may include a path (e.g., defined by a set of coordinates) between point A and point B for the extraterrestrial vehicle to follow, times when the thrust of the extraterrestrial vehicle should be activated or deactivated, and/or the like. At [E], the navigation system 230 receives the instructions.

At [F], the navigation system 230 adjusts the movement of the extraterrestrial vehicle 205 according to the generated instructions. In some examples, the navigation system 230 may provide the parameters to the engine controls for adjusting the movement of the extraterrestrial vehicle 205 as disclosed herein. For example, the engine controls may adjust movement with respect to the navigation parameters from the navigation system 230 (for example, increasing or reducing thrust according to the navigation parameters). The generated instructions may cause the navigation system 230 to update the parameters with respect to another orbital trajectory. For example, the updated orbital trajectory may be different than the original orbital trajectory. In this way, the extraterrestrial vehicle 205 may move from the original orbital trajectory to the updated orbital trajectory. The change in orbital trajectories may rely on activating the low-thrust engines at specified times along the original orbital trajectories to adjust the movement of the extraterrestrial vehicle 205 to the updated orbital trajectory. For example, to move from a LEO to a higher orbit, the space-based computing system 220 may calculate a transfer orbit burn with low-thrust engines. The low-thrust engines of the extraterrestrial vehicle 205 then executes the burn to increase velocity, moving the extraterrestrial vehicle 205 into an elliptical transfer orbit. At the apogee of this orbit, another burn is performed to circularize the orbit, achieving the final desired orbit.

### Example Orbital Transfer Diagrams and Graphs

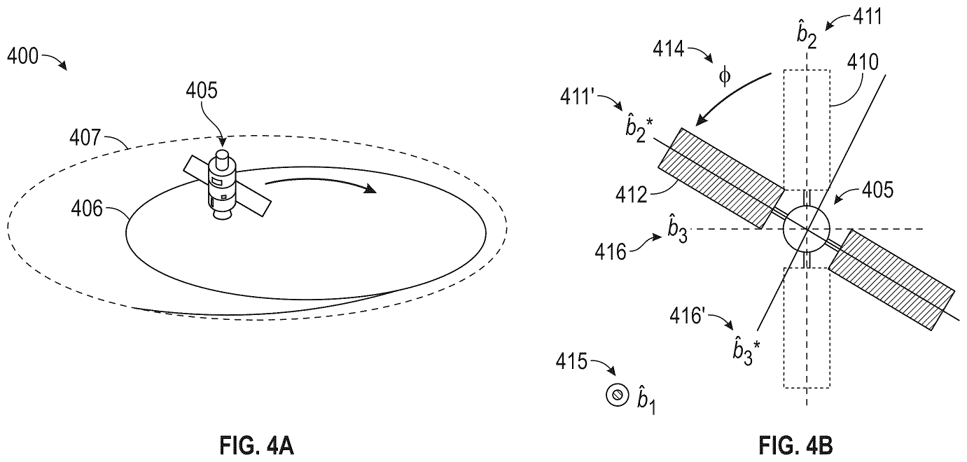

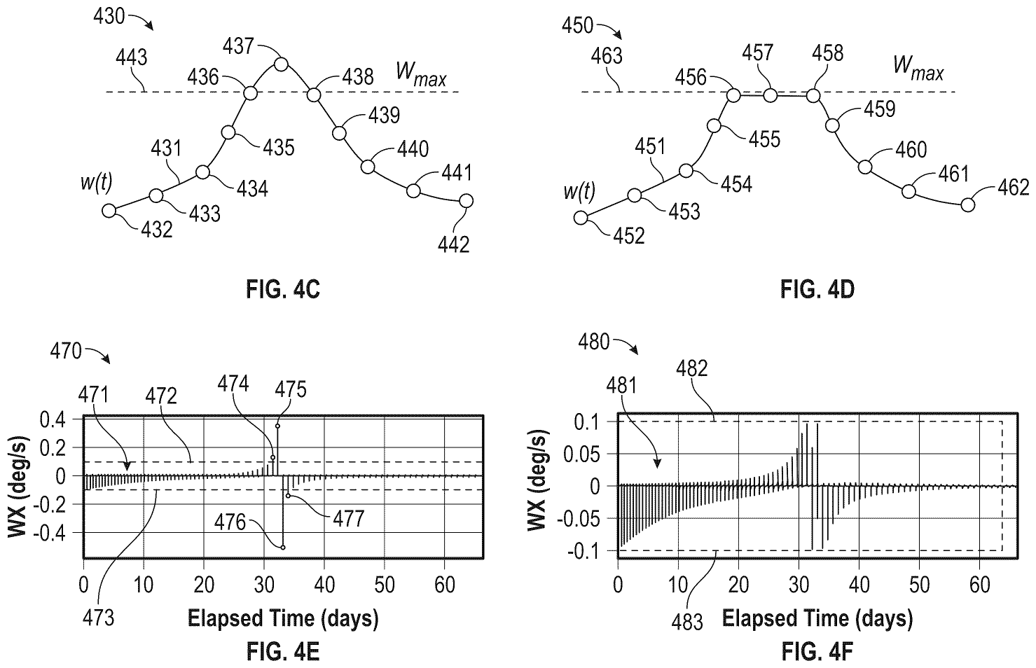

FIGS. 4A-4D illustrate diagrams and graphs of mitigating snap-roll events for an extraterrestrial vehicle in an orbital transfer. The approaches illustrated in FIGS. 4A-4D may be completed, for example, by a space-based computing system, according to one embodiment. As an example, the space-based computing system 220 of FIG. 2 may perform the approaches as described for FIGS. 4A-4D.

FIGS. 4A-4B illustrate an extraterrestrial vehicle 405 implementing an orbit change maneuver. The extraterrestrial vehicle 405 may be as described herein (for example, the extraterrestrial vehicle 205). The extraterrestrial vehicle 405 may adjust a trajectory from a first orbit 406 to a second orbit 407 according to an attitude profile (for example, a nominal attitude profile). As described herein, a nominal attitude of the extraterrestrial vehicle 405 may be where the first axis of the body frame is aligned with the thrust direction of the extraterrestrial vehicle 405. The first axis may be based on a low-thrust trajectory design algorithm which identifies a control direction over the course of the transfer. As shown in FIG. 4B, the extraterrestrial vehicle 405 may be in a first orientation 410 with a first body axis 415 (pointing out from the page), a second body axis 411 in a first direction, and a third body axis 416 in a second direction. The axes may provide a nominal coordination system for the extraterrestrial vehicle 405, with each of the axes orthogonal from another. The extraterrestrial vehicle 405 may be in a second orientation 412 with the first body axis 415 remaining in a same direction as the in the first orientation 410, the second body axis 411′ in a third direction (that may be different than the first direction), and the third body axis 416′ in a fourth direction (that may be different than the second direction). The second orientation of the extraterrestrial vehicle 405 may occur due to a rotation about the first body axis 415 by an angle 414. The axis 411 (and axis 411′) of the extraterrestrial vehicle 405 may be along a solar panel and is located orthogonal to the thruster direction (which may be along the first body axis 415). The nominal attitude of the axis 411 (and axis 411′) may be the direction of the cross product of the first body axis 415 and the direction from the extraterrestrial vehicle 405 to the sun (for example, as shown in FIGS. 1A and 1B) such that the axis 411 (and axis 411′) may be orthogonal to the direction of the sun. The third axis 416 (and 416′) of the nominal body completes the right-handed coordinate frame.

A snap-roll scenario may occur according to the attitude. For example, in response to the angle between the thrust direction (the first body axis 415, \hat{b}₁) (or the direction of another axis that the extraterrestrial vehicle 405 is attempting to maintain, such as an axis that aligns with a communication system, an area of space to which a telescope is directed, a target in space or on ground, etc.) and the direction of the sun from the extraterrestrial vehicle 405, s, approaching 0° or +/−180°. In this case, the magnitude of the cross product between the two directions may approach zero, and definition of the second body axis approaches a singularity. As a result of this singularity, the extraterrestrial vehicle 405 may experience extremely rapid rotations about the first body axis when adhering to the nominal attitude definition (such as, a snap-roll event).

In some examples, the extraterrestrial vehicle 405 may apply various approaches to maintaining alignment of a target vector during a snap-roll event. For example, there may be alternative attitude profiles to satisfy agility constraints during snap-roll events. In some cases, the extraterrestrial vehicle 405 may maintain the solar panel axis pointing such that the extraterrestrial vehicle 405 can continue generating full solar power during the snap-roll event. In this approach, the thruster axis of the extraterrestrial vehicle 405 may be temporarily misaligned from a reference thrust direction to satisfy the agility constraints. The alignment between the thrust direction (or direction of another axis) and the direction from the extraterrestrial vehicle 405 to the Sun may be based on the low-thrust transfer geometry and the epoch of the transfer, which determines the orientation of Earth-Sun-spacecraft system. In another approach, the extraterrestrial vehicle 405 may hold the thruster axis aligned with the reference thrust direction then modify the solar panel axis until the angular constraints of the extraterrestrial vehicle 405 are met. In this case, the approach may cause a temporary reduction in a solar power generation due to the off-pointing of the solar arrays. However, the translational motion of the extraterrestrial vehicle 405 can remain largely unaffected by the snap-roll event if the extraterrestrial vehicle 405 can generate enough power during the snap-roll. In another approach, the extraterrestrial vehicle 405 may apply a combination of the approaches to balance thruster and solar panel axis off-pointing during a snap-roll event. In some cases, the extraterrestrial vehicle 405 may maintain alignment of another axis with a reference during a snap-roll event. For example, the extraterrestrial vehicle 405 may maintain a first axis along a reference axis and adjust a second axis relative to the first axis to ensure the extraterrestrial vehicle 405 meets operational constraints. For example, in some cases, the first axis may be the solar axis, and the second axis may be an axis associated with: a communications system or relay, an antenna, an area of space to capture with a telescope, a defense target, and/or the like. The extraterrestrial vehicle 405 may maintain the solar axis to produce solar power while adjusting a position of the second axis. In other approaches, the extraterrestrial vehicle 405 may maintain the second axis while adjusting the first axis.

In some cases, the vectors may align once per revolution of the extraterrestrial vehicle 405. The rotation of the nominal attitude definition may be increased if a rate of the change of the thrust vector direction (or direction of another axis) as it passes near the spacecraft-Sun line is increased, such as during a periapsis of a transfer.

In response to identifying each snap-roll event in the transfer, the extraterrestrial vehicle 405 may compute each snap-roll event (for example, sequentially via an optimization process defined for each event). In some cases, for each snap-roll event, a time bound may encapsulate the timespan of the attitude that violates the angular constraint limit, as well as sufficient time on both sides of the violation where the attitude may be modified. The center of the timespan may be at the point of the maximum magnitude of the angular velocity about \hat{b}₁.

The amount of time before and after the angular rate violation timespan may be based on parameters of the extraterrestrial vehicle 405. For example, the parameters may include an angular rate, acceleration limit, and/or the like. In response to a reduced angular rate or acceleration limits, the extraterrestrial vehicle 405 may rely on increased time to distribute a roll maneuver over time (such as, compared to a system with higher limits). In some examples, the time range may be longer than what is dictated by the parameters of the extraterrestrial vehicle 405. The angular rate constraint may be between 0 degrees/second and 1 degree/second, for example, 0.1 degrees/second. The trajectory optimizer 224 may automatically detect when the extraterrestrial vehicle 405 can remain on the nominal attitude definition to maintain solar power generation (such as target solar power generation, e.g., between 0-100%).

For each snap-roll event, the extraterrestrial vehicle 405 may identify discrete control points along the attitude. For example, the extraterrestrial vehicle 405 may generate N-number of discrete control points distributed over the selected time bounds. The discrete control points may be distributed evenly over time. In some cases, the extraterrestrial vehicle 405 may apply an adaptative approach. For example, the extraterrestrial vehicle 405 may cluster the discrete control points along a particular portion of the time bounds. In some cases, the quantity of discrete control points may impact the accuracy of finite-differencing approximations between each discrete control point and the total number of variables within the optimization problem. The concept of finite-differencing is described in greater detail below.

FIGS. 4C-4D illustrate example control points and the desired outcome of snap-roll mitigation. For example, FIGS. 4C-4D depict a one-dimensional representation of the angular rates of the extraterrestrial vehicle 405 over time, w (t), and a constraint on the maximum angular velocity, labeled as @max. As shown in FIG. 4C, line 431 represents a continuous time history of the angular rate and control points 432-442 each represent discrete control points, with control points 436, 437, 438 at least meeting (and/or exceeding) a target angular velocity 433. The control points 432-442 may be discrete moments during movement of the extraterrestrial vehicle 405 for which the extraterrestrial vehicle 405 may execute instructions to adjust movement. FIG. 4C illustrates motion of the extraterrestrial vehicle 405 prior to snap-roll mitigation. In some cases, the density of discrete control points may be at a density sufficient to capture the violation of angular rates. The density of the discrete control points may correspond to an even (or an uneven) distribution across time bounds of the snap-roll event. As shown in FIG. 4D, line 451 represents a continuous time history of the angular rate and control points 452-462 each represent discrete control points, with control points 456, 457, 458 being adjusted to be at or below a target angular velocity 463. FIG. 4D illustrates an example profile of control points that may satisfy the angular constraint (the target angular velocity 463). In this case, the angular rates about the second body axis 411 and third axis 416 as well as the angular accelerations corresponding to each axis, are also constrained.

The extraterrestrial vehicle 405 may compute attitude at each control point according to the angle between the second body axis 411 at the second orientation

$$( {\hat{b}}_{2}^{*} )$$

and the second body axis 411′ at the first orientation (\hat{b}₂), as illustrated in FIG. 4B. Even though the computations described herein are focused on the second body axis 411, the extraterrestrial vehicle 405 may perform computations about each of the axes. While the snap-roll mitigation strategy identifies and processes angular velocity and acceleration violations about \hat{b}₁, the angular rates about all three body axes can be evaluated for violations of respective angular rate constraints. In this way, the extraterrestrial vehicle 405 may modify the second body axis as a single-axis rotation about the first body axis, \hat{b}₁. The controlled second body axis may be expressed as:

$${\hat{b}}_{2}^{*} = R [ ϕ , {\hat{b}}_{1} ] {\hat{b}}_{2} \qquad ( 4 )$$

Where the notation of R[θ, \hat{x}] denotes a rotation of angle θ about axis \hat{x}. Inversely, the control variable, φ, may be calculated as:

$$ϕ = {cos}^{- 1} ( {\hat{b}}_{1} \cdot {\hat{b}}_{2}^{*} ) \qquad ( 5 )$$

In some cases, the extraterrestrial vehicle 405 may determine whether the movement by the extraterrestrial vehicle 405 may include a flip across one or more axis. In this case, the extraterrestrial vehicle 405 may perform a sign check to determine a unique angle definition. In response to

$${\hat{b}}_{2}^{*} \cdot {\hat{b}}_{3} < 0 ,$$

then φ→2π−φ. The variables for adjusting position of the extraterrestrial vehicle 405 to mitigate snap-roll events are thus the roll angles for each control point, denoted as:

$$V = {[ \begin{matrix}{ϕ}_{2} & {ϕ}_{3} & … & {ϕ}_{N - 2} & {ϕ}_{N - 1}\end{matrix} ]}^{T} \qquad ( 6 )$$

In some examples, the angles of first and last control point, φ₁ and φ_{N}, respectively, may be boundary conditions.

The extraterrestrial vehicle 405 may compute angular velocity during the snap-roll event via finite-differencing. For example, the extraterrestrial vehicle 405 may generate a rotation matrix of the body frame with the new second body axis using the thrust direction at the control point as:

$${[ R ]}_{i} = {[ \begin{matrix}{\hat{b}}_{1}^{T} \\ {b}_{2}^{* T} \\ {( {\hat{b}}_{1} \times {\hat{b}}_{2}^{*} )}^{T}\end{matrix} ]}_{i} \qquad ( 7 )$$

The extraterrestrial vehicle 405 may compute rotation matrix between two successive control points as:

$${[ dR ]}_{i} = {{[ R ]}_{i + 1}^{T} [ R ]}_{i} \qquad ( 8 )$$

The extraterrestrial vehicle 405 may compute the angular velocity of the body frame of the extraterrestrial vehicle 405 with respect to the inertial frame is approximated via forward finite differencing, as:

$${\vec{ω}}_{i} \approx ( \frac{Φ}{{t}_{i + 1} - {t}_{i}} ) \hat{e} \qquad ( 9 )$$

Where Φ and ê are the principal rotation angle and axis representation of the rotation matrix, [dR]ᵢ. The extraterrestrial vehicle 405 may compute angular acceleration of the body frame with respect to the inertial frame, for example, using forward finite differencing as:

$${\vec{α}}_{i} \approx ( \frac{{\vec{ω}}_{i + 1} - {\vec{ω}}_{i}}{{t}_{i + 1} - {t}_{i}} ) \hat{e} \qquad ( 10 )$$

The extraterrestrial vehicle 405 may compute angular velocity and angular acceleration at each control point to define inequality constraints determined by agility constraints of the extraterrestrial vehicle 405. The following inequality constraints are defined for each control point:

$${\vec{ω}}_{min} \leq {\vec{ω}}_{i} \leq {\vec{ω}}_{max} , \qquad ( 11 a )$$

$${\vec{α}}_{min} \leq {\vec{α}}_{i} \leq {\vec{α}}_{max} \qquad ( 11 b )$$

In some cases, the inequality constraints may result in 12 inequality constraints defined per control point for a total of 12*N inequality constraints, where N is the number of control points.

The extraterrestrial vehicle 405 may identify a cost function for snap-roll mitigation that parameterizes the solar power generation loss during the snap-roll event. The cost function may be:

$$minimize J = {\sum }_{i = 1}^{N} {( {\hat{s}}_{i} \cdot {\hat{b}}_{2 , i} )}^{2} \qquad ( 12 )$$

The cost function may reduce the square sum of the cosine of the angle between the second body axis (such as, the solar panel axis) and the direction of the Sun from the extraterrestrial vehicle 405. The lowest possible cost function of zero corresponds to the solar panel axis remaining orthogonal to the vehicle-sun line at every control point.

In response to a snap-roll event being processed and a set of valid control points being found, the extraterrestrial vehicle 405 may update the end-to-end attitude history with discrete attitude at each control point. For example, the extraterrestrial vehicle 405 may apply an interpolation scheme (such as, a Chebyshev polynomial-based approach). In some examples, the extraterrestrial vehicle 405 may apply a scaling factor of less than one to the angular velocity and acceleration constraint values within the computation of mitigating snap-roll events. In this way, the extraterrestrial vehicle 405 may prevent overshoot of the angular constraints during interpolation of the attitude history output.

In some examples, for each snap-roll event, the extraterrestrial vehicle 405 may determine whether to flip an orientation about one or more axes. For example, the extraterrestrial vehicle 405 may compute a first case and a second case for solar power generation profiles. In the first case, the extraterrestrial vehicle 405 enters and exits the snap-roll event using the same attitude profile defined in Equation (1) (for example, the sign of the definition of the second body axis is the same). In this way, the first case is considered a snap-roll event without a flip. In the second case, the sign of the second body axis at the exit of the snap-roll event is opposite of the sign of the second body axis upon entering the snap-roll event. The flip of the second case may result in reduced rotation about the first body axis as compared to the first case due to the geometry of the snap-roll event.

For example, each of the first case and the second case apply a different set of initial conditions. In the first case, the initial guess for the variables in the snap-roll event is the nominal attitude. For the second case, the variables are defined as 0° for the first half of the event and 180° for the second half of the transfer. In this way, the attitude of the final control point, φ_{N}, is defined as 180° to apply the boundary constraint.

In some cases, for each snap-roll event, the extraterrestrial vehicle 405 may compute the first case and the second case. The extraterrestrial vehicle 405 may generate instructions according to the case with the cost function resulting in lower solar power reduction. If the second case is chosen, the attitude history following the snap-roll event may be updated to reflect the update in the second body axis sign. As this process repeats for each snap-roll event, the sign used in the definition of the second body axis may change multiples times in a single orbit transfer.

FIGS. 4E-4F illustrate graphs representing time histories of unconstrained angular velocity about the first body axis over the length of the transfer. Angular velocity graph 470 plots angular velocity 471 with respect to a first limit 472 and a second limit 473 (the limits may be +/−0.1 degree/second). The angular velocity 471 may exceed the first limit 472 and/or the second limit 473 at various times during the length of the transfer, as denoted by violation events 474, 475, 476, 477. Angular velocity graph 480 plots angular velocity 481 with respect to a first limit 482 and a second limit 483 (the limits may be +/−0.1 degree/second). The angular velocity 481 may be below or at the first limit 482 and/or the second limit 483 in response to the extraterrestrial vehicle 405 adjusting movement to reduce angular velocity.

The extraterrestrial vehicle 405 may apply the snap-roll mitigation process to each snap-roll event, for example, sequentially in time. As an illustrative example, for each snap-roll event, a one-hour time bound is defined surrounding the peak of the roll-rate violation. Each control point (for example, as described in FIGS. 4C-4D) may be distributed evenly in time at a time step of 1 minute for a total of 61 control points per snap-roll mitigation computation.

The extraterrestrial vehicle 405 may compute solar power generation during each snap-roll event. As an illustrative example, each processed snap-roll event may result in a solar power generation loss of less than 0.11%, corresponding to an off-pointing angle of the solar panel axis of no more than 2.8°. In some cases, the extraterrestrial vehicle 405 may determine whether the solar power generation is different for a flip event. The extraterrestrial vehicle 405 may update the attitude profile for each snap-roll event.

### Example Extraterrestrial Vehicle Course Correction Routine

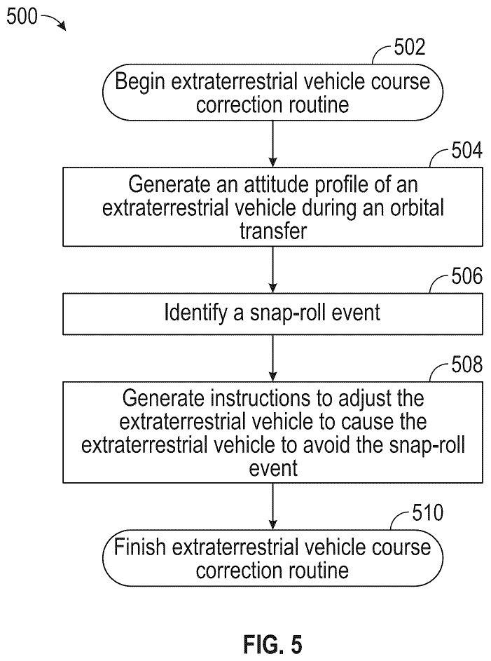

FIG. 5 is a flow diagram depicting an example course correction routine 500 illustratively implemented by a space-based computing system, according to one embodiment. As an example, the space-based computing system 220 of FIG. 2 can be configured to execute the course correction routine 500. The course correction routine 500 begins at block 502.

At block 504, the space-based computing system 220 generates an attitude profile of the extraterrestrial vehicle during an orbital transfer. The attitude profile may identify a direction for a first vector and a second vector of the extraterrestrial vehicle. The first vector may be associated with a thrust vector (such as a direction of acceleration of the vehicle), a solar vector (such as a positioning of the vehicle to allow for a solar panel of the vehicle to receive sunlight), a vector associated with a communications system or relay, a vector associated with an antenna, a vector associated with an area of space to capture with a telescope, a vector associated with a defense target, and/or the like. The second vector may be associated with a thrust vector (such as a direction of acceleration of the vehicle), a solar vector (such as a positioning of the vehicle to allow for a solar panel of the vehicle to receive sunlight), a vector associated with a communications system or relay, a vector associated with an antenna, a vector associated with an area of space to capture with a telescope, a vector associated with a defense target, and/or the like. The space-based computing system 220 may generate the attitude profile of the extraterrestrial vehicle during the orbital transfer as disclosed herein (for example, the space-based computing system 220 in FIG. 2). In some cases, the extraterrestrial vehicle may be the extraterrestrial vehicle (such as, extraterrestrial vehicle 205, 405, as described herein).

At block 506, the space-based computing system 220 identifies a snap-roll event. In some examples, the space-based computing system 220 may identify, from the attitude profile, the snap-roll event. The snap-roll event may be a violation event in which movement of the vehicle violates a body-frame angular rate constraint. In some examples, the body-frame angular rate constraint includes a target angular velocity range for the vehicle. The space-based computing system 220 may identify the snap-roll event based on the first vector (such as the solar vector) and the second vector (such as the thrust vector) being in substantial alignment. For example, a thrust vector and a solar vector may be in substantial alignment. Substantial alignment may include the solar vector being between 0-degrees and 5-degrees offset from the thrust vector. In some examples, the vectors may be in moderate alignment. Moderate alignment may include the vectors being between 5-degrees and 90-degrees offset. The space-based computing system 220 may identify the snap-roll event from operational motion characteristics according to the attitude profile. The operational motion characteristics may include at least one of angular velocity rates and angular acceleration limits of the vehicle. The space-based computing system 220 may identify time bounds around the violation event. The snap-roll event may occur within the time bounds. The time bounds of the violation event may be between 0 seconds and 360 seconds, or another value outside of the presented values or range. In some cases, the time bounds of the violation event may be adjustable. In some examples, the space-based computing system 220 may generate a cost function associated with the snap-roll event. The cost function may be designed to reduce solar power generation losses and determine constraints defined on the operational motion characteristics of the time bounds. In some cases, the space-based computing system 220 may generate an initial solution for computing the cost function using operational motion characteristics from the attitude profile. The space-based computing system 220 may interpolate the operational motion characteristics across the time bounds to determine an optimal attitude path for the vehicle. In some examples, identify a plurality of control points along a trajectory of the vehicle during the snap-roll event. The space-based computing system 220 may, for each snap-roll event, determine control parameters for some of the plurality of control point. In this way, the space-based computing system 220 may interpolate the operational motion characteristics between the plurality of control points to determine an optimal attitude path for the vehicle. The space-based computing system 220 may identify, from the attitude profile, the snap-roll event as disclosed herein (for example, the space-based computing system 220 in FIG. 2).

At block 508, the space-based computing system 220 generates instructions to avoid the snap-roll event. In some examples, the space-based computing system 220 may generate instructions to adjust an angular velocity of the extraterrestrial vehicle. For example, the space-based computing system 220 may generate the instructions according to spacecraft constraints to cause the extraterrestrial vehicle to maintain alignment with the attitude profile and avoid the snap-roll event. In some examples, the space-based computing system 220 may generate the instructions during a time period corresponding to the snap-roll event to satisfy a target angular velocity. In some examples, the space-based computing system 220 may adjust angular velocity of the vehicle at a first control point in the plurality of control points. A first angular velocity of the vehicle at the first control point may exceed a maximum angular velocity of the vehicle. The adjustment of the angular velocity of the vehicle to satisfy the target angular velocity may cause the extraterrestrial vehicle to, during at least a portion of the time period, maintain the first vector (such as a thrust vector) along the attitude profile, off-point the second vector (such as solar vector) from the attitude profile, and avoid the snap-roll event. In some examples, the space-based computing system 220 may generate instructions that cause adjustments to the angular velocity of the vehicle to be within a target angular velocity range for at least some time of time bounds around the violation event. In some examples, the space-based computing system 220 may compute a first solar power generation estimate for a first case. The first case may be an estimated amount of solar power generation in response to flipping of the vehicle. The space-based computing system 220 may compute a second solar power generation estimate for a second case. The second case may be an estimated amount of solar power generation without flipping. The space-based computing system 220 may determine whether to cause the vehicle to flip along an axis of the vehicle. The determination may be based on a comparison between the first case and the second case. In response to a determination that the first solar power generation estimate is greater than the second solar power generation estimate, the space-based computing system 220 may generate a second instruction to cause the vehicle to flip along the axis. The space-based computing system 220 may generate the instructions, as disclosed herein (for example, the space-based computing system 220 in FIG. 2). Accordingly, the course correction routine 500 ends, as shown at block 510.

In the above description of FIG. 5, any blocks described can include alternate implementations within the scope of the example embodiments of the present disclosure in which the blocks can be executed out of order from that shown or discussed, including substantially concurrently or in reverse order, depending upon the functionality involved, as would be understood by those skilled in the art. The various elements, features, and processes described herein may be used independently of one another, or may be combined in various ways. All possible combinations and sub-combinations are intended to fall within the scope of this disclosure.

### Example Attitude Optimization Routine

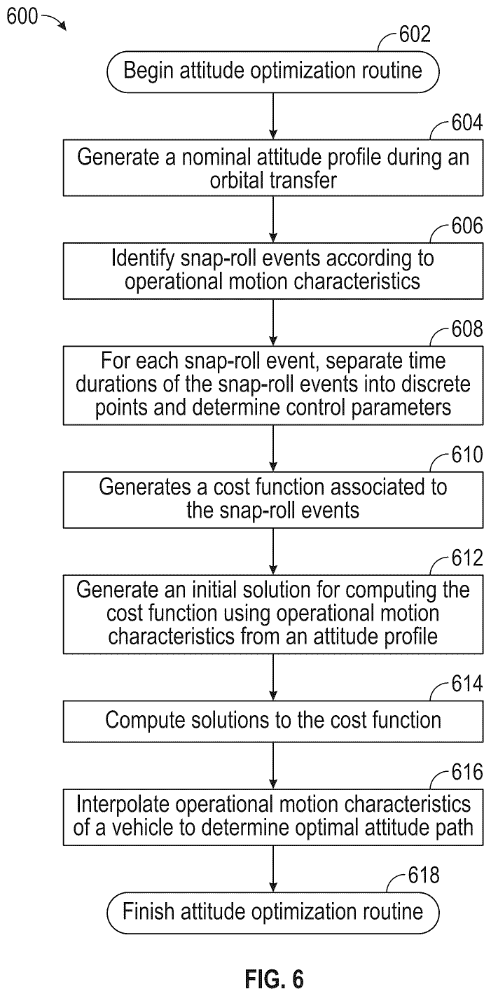

FIG. 6 is a flow diagram depicting an example attitude optimization routine 600 illustratively implemented by a space-based computing system, according to one embodiment. As an example, the space-based computing system 220 of FIG. 2 can be configured to execute the attitude optimization routine 600. The attitude optimization routine 600 begins at block 602.

At block 604, the space-based computing system generates a nominal attitude profile during an orbital transfer. The generation of the nominal attitude profile may enable full solar power generation. The generation of the nominal attitude profile may have aspects as described herein. The space-based computing system 220 may receive (or generate) the reference trajectory for an extraterrestrial vehicle based on the initial state of the extraterrestrial vehicle and the user-specified target to which the extraterrestrial vehicle is intended to travel as disclosed herein (for example, the space-based computing system 220 in FIG. 2).

At block 606, the space-based computing system identifies snap-roll events according to operational motion characteristics. For example, the operational motion characteristics may include angular velocity rates and angular acceleration limits of the extraterrestrial vehicle. In this way, the space-based computing system 220 may determine one or more time durations for when the operational motion characteristics reach threshold values and/or limits associated with the particular characteristic. Identifying the snap-roll events may have aspects as described herein. The space-based computing system 220 may identify the snap-roll events according to the operational motion characteristics as disclosed herein (for example, the space-based computing system 220 in FIG. 2).

At block 608, the space-based computing system, for each snap-roll event, may separate the time durations into discrete points and determine control parameters at each of the discrete points. Separating the time durations into discrete points may have aspects as described herein. The space-based computing system 220 may separate the time durations into discrete points and determine control parameters at each of the discrete points as disclosed herein (for example, the space-based computing system 220 in FIG. 2).

At block 610, the space-based computing system generates a cost function associated with the snap-roll events. In some cases, the space-based computing system 220 may generate the cost function designed to reduce solar power generation losses and determine constraints defined on operational motion characteristics, such as angular rate and angular acceleration between neighboring control points. The generation of the cost function may be as described herein. The space-based computing system 220 may generate the cost function associated with the snap-roll events as disclosed herein (for example, the space-based computing system 220 in FIG. 2).

At block 612, the space-based computing system generates an initial solution for computing the cost function using operational motion characteristics from an attitude profile. In some examples, the space-based computing system 220 may obtain the initial solution from boundary conditions from an orbital trajectory. The initial solution may be determined as described herein. The space-based computing system 220 may generate the initial solution for computing the cost function using the operational motion characteristics from the attitude profile as disclosed herein (for example, the space-based computing system 220 in FIG. 2).

At block 614, the space-based computing system computes solutions to the cost function using analytical techniques. In some cases, the space-based computing system 220 may apply gradient-based optimization techniques to compute the solutions to the cost function. The computation of the solutions may be as described herein. The space-based computing system 220 may compute solutions to the cost function using the analytical techniques as disclosed herein (for example, the space-based computing system 220 in FIG. 2).

At block 616, the space-based computing system interpolates operational motion characteristics of the extraterrestrial vehicle to determine an optimal attitude path. For example, the space-based computing system may interpolate the attitude and angular rates between discrete control points. The interpolation of the operational motion characteristics may be as determined herein. In some cases, the space-based computing system may repeat some or all of the steps for each snap-roll event during the transfer. The space-based computing system 220 may interpolate the operational motion characteristics of the extraterrestrial vehicle to determine the optimal attitude path as disclosed herein (for example, the space-based computing system 220 in FIG. 2). Accordingly, the attitude optimization routine 400 ends, as shown at block 618.

In the above description of FIG. 6, any blocks described can include alternate implementations within the scope of the example embodiments of the present disclosure in which the blocks can be executed out of order from that shown or discussed, including substantially concurrently or in reverse order, depending upon the functionality involved, as would be understood by those skilled in the art. The various elements, features, and processes described herein may be used independently of one another, or may be combined in various ways. All possible combinations and sub-combinations are intended to fall within the scope of this disclosure.

### Example Computing System

FIG. 7 illustrates various components of an example computing system 700 configured to implement various functionality as described herein. In some examples, the computing system 700 could also integrate the functionality of the extraterrestrial vehicle 205. In some embodiments, as shown, the computing system 700 may include: one or more computer processors 702, such as physical central processing units (“CPUs”), FPGAs, ASICs, and/or the like; one or more network interfaces 704, such as a network interface cards (“NICs”); one or more computer-readable medium drives 706, such as a high density disk (“HDDs”), solid state drives (“SSDs”), flash drives, and/or other persistent non-transitory computer-readable media; one or more datastore 708, such as physical storage and/or remote storage, and/or other data storage components; and one or more computer-readable memories 720, such as random access memory (“RAM”) and/or other volatile non-transitory computer-readable media.

The computer-readable memory 720 may include computer program instructions that one or more computer processors 702 execute in order to implement one or more embodiments. The computer-readable memory 720 can store an operating system 722 that provides computer program instructions for use by the computer processor(s) 702 in the general administration and operation of the deceleration system 210.

In some embodiments, the computer-readable memory 720 can further include computer program instructions and other information for implementing aspects of the present disclosure. For example, the computer-readable memory 720 may include vehicle state instructions 724 for obtaining states of a vehicle, as described herein. As another example, the computer-readable memory 720 may include trajectory instructions 726 for determining adjustments to trajectory for an orbital transfer, as described herein. As another example, the computer-readable memory 720 may include navigation instructions 728 for determining changes to movement of the extraterrestrial vehicle, as described herein.

When a routine is initiated, a corresponding set of executable program instructions stored on a computer-readable medium drive 706 may be loaded into computer-readable memory 720 and executed by one or more computer processors 702. In some embodiments, a routine—or portions thereof—may be implemented on multiple computing devices and/or multiple processors, serially or in parallel.

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or logic circuitry that implements a state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, or steps. Thus, such conditional language is not generally intended to imply that features, elements, or steps are in any way required for one or more embodiments or that one or more embodiments necessarily include logic for deciding, with or without other input or prompting, whether these features, elements, or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A vehicle capable of operating in space, the vehicle comprising:
a memory that stores computer-executable instructions; and
a processor in communication with the memory, wherein the computer-executable instructions, when executed by the processor, cause the processor to:
generate an attitude profile of the vehicle during an orbital transfer, wherein the attitude profile identifies a direction for a thrust vector and a solar vector, wherein the thrust vector is associated with a direction of acceleration of the vehicle, wherein the solar vector is associated with a positioning of the vehicle to allow for a solar panel of the vehicle to receive sunlight;
identify, from the attitude profile, a snap-roll event, wherein the snap-roll event is a violation event in which movement of the vehicle violates a body-frame angular rate constraint, wherein the snap-roll event is identified based on the solar vector and the thrust vector being in substantial alignment; and
generate instructions to adjust an angular velocity of the vehicle during a time period corresponding to the snap-roll event to satisfy a target angular velocity, wherein adjustment of the angular velocity of the vehicle to satisfy the target angular velocity causes the vehicle to, during at least a portion of the time period, maintain the thrust vector along the attitude profile, off-point the solar vector from the attitude profile, and avoid the snap-roll event.

2. The vehicle of claim 1, wherein the body-frame angular rate constraint includes a target angular velocity range for the vehicle.

3. The vehicle of claim 1, wherein the computer-executable instructions of the vehicle, when executed, further cause the processor to identify the snap-roll event from operational motion characteristics according to the attitude profile, wherein the operational motion characteristics include at least one of angular velocity rates and angular acceleration limits of the vehicle.

4. The vehicle of claim 3, wherein the computer-executable instructions of the vehicle, when executed, further cause the processor to identify time bounds around the violation event, wherein the snap-roll event occurs within the time bounds.

5. The vehicle of claim 4, wherein the computer-executable instructions of the vehicle, when executed, further cause the processor to generate a cost function associated with the snap-roll event, wherein the cost function is designed to reduce solar power generation losses and determine constraints defined on the operational motion characteristics of the time bounds.

6. The vehicle of claim 5, wherein the computer-executable instructions of the vehicle, when executed, further cause the processor to generate an initial solution for computing the cost function using operational motion characteristics from the attitude profile.

7. The vehicle of claim 6, wherein the computer-executable instructions of the vehicle, when executed, further cause the processor to interpolate the operational motion characteristics across the time bounds to determine an optimal attitude path for the vehicle.

8. The vehicle of claim 1, wherein the computer-executable instructions of the vehicle, when executed, further cause the processor to generate instructions that cause adjustments to the angular velocity of the vehicle to be within a target angular velocity range for at least some time of time bounds around the violation event.

9. The vehicle of claim 8, wherein the time bounds of the violation event is one minute.

10. The vehicle of claim 8, wherein the time bounds of the violation event is adjustable.

11. The vehicle of claim 1, wherein the computer-executable instructions of the vehicle, when executed, further cause the processor to:
compute a first solar power generation estimate for a first case, wherein the first case is an estimated amount of solar power generation in response to flipping of the vehicle;
compute a second solar power generation estimate for a second case, wherein the second case is an estimated amount of solar power generation without flipping;
determine whether to cause the vehicle to flip along an axis of the vehicle, wherein the determination is based on a comparison between the first case and the second case; and
in response to a determination that the first solar power generation estimate is greater than the second solar power generation estimate, generate a second instruction to cause the vehicle to flip along the axis.

12. A method comprising:
obtaining a direction for a thrust vector and a solar vector of an extraterrestrial vehicle, wherein the thrust vector is associated with a direction of acceleration of the extraterrestrial vehicle, wherein the solar vector is associated with a positioning of the extraterrestrial vehicle to allow for a solar panel of the extraterrestrial vehicle to receive sunlight;
identifying a position along a trajectory for which the solar vector and the thrust vector are in substantial alignment; and
in response to identifying the position, generating instructions to adjust an angular velocity of the extraterrestrial vehicle at the position to satisfy a target angular velocity, wherein adjustment of the angular velocity of the extraterrestrial vehicle to satisfy the target angular velocity causes the extraterrestrial vehicle to, at the position, maintain the thrust vector and off-point the solar vector.

13. The method of claim 12, wherein the target angular velocity is within a target angular velocity range for the extraterrestrial vehicle.

14. The method of claim 12 further comprising identifying alignment of the solar vector and the thrust vector from operational motion characteristics of the extraterrestrial vehicle, wherein the operational motion characteristics include at least one of angular velocity rates and angular acceleration limits of the extraterrestrial vehicle.

15. The method of claim 14 further comprising identifying time bounds around alignment of the solar vector and the thrust vector.

16. The method of claim 15 further comprising generating instructions that cause adjustments to the angular velocity of the extraterrestrial vehicle to be within a target angular velocity range for at least some time of time bounds.

17. The method of claim 15 further comprising generating a cost function associated with alignment of the solar vector and the thrust vector, wherein the cost function is designed to reduce solar power generation losses and determine constraints defined on the operational motion characteristics of the time bounds.

18. The method of claim 17 further comprising generating an initial solution for computing the cost function using operational motion characteristics.

19. The method of claim 18 further comprising interpolating the operational motion characteristics across the time bounds to determine an optimal attitude path for the extraterrestrial vehicle.

20. The method of claim 12 further comprising:
computing a first solar power generation estimate for a first case, wherein the first case is an estimated amount of solar power generation in response to flipping of the extraterrestrial vehicle;
computing a second solar power generation estimate for a second case, wherein the second case is an estimated amount of solar power generation without flipping;
determining whether to cause the extraterrestrial vehicle to flip along an axis of the extraterrestrial vehicle, wherein the determination is based on a comparison between the first case and the second case; and
in response to a determination that the first solar power generation estimate is greater than the second solar power generation estimate, generating a second instruction to cause the extraterrestrial vehicle to flip along the axis.
